(19) United States
(12) Patent Application Publication
(10) Pub. No.: US 2022/0186003 A1
(43) Pub. Date: Jun. 16, 2022

(54) SURFACE COVERING INCLUDING A POLYESTER-POLYOLEFIN-BLEND CORE

(71) Applicant: AFI Licensing LLC, Lancaster, PA (US)

(72) Inventors: DANIEL BAKER, Downingtown, PA (US); THOMAS FRY, Shakopee, MN (US); HEATHER CALLAGHAN, Dover, PA (US); CAITLIN NELLIGAN, Lancaster, PA (US); JESSICA PURAWIC, Bourbannais, IL (US); RAYMOND MILLER, Dillsburg, PA (US); RACHAEL VAN PELT, Bourbonnais, IL (US)

(73) Assignee: AFI Licensing LLC, Lancaster, PA (US)

(21) Appl. No.: 17/598,757

(22) PCT Filed: Mar. 26, 2020
(86) PCT No.: PCT/US2020/025080

§ 371 Date: Sep. 27, 2021

Related U.S. Application Data
(60) Provisional application No. 62/823,787, filed on Mar. 26, 2019.

(51) Int. Cl. C08L 23/06; E04F 13/18; E04F 15/10

(52) U.S. Cl. CPC C08L 23/06; E04F 13/18; C08L 2207/20; C08L 2205/03; C08L 2207/04; E04F 15/105

(57) ABSTRACT

Included are a decorative floor or wall covering including a core and a core that can included recycled materials. This core includes a polyester comprising a polyester or copolyester derived from a reaction of a difunctional carboxylic acid and a difunctional hydroxyl compound; a polyolefin, at least one functionalized polymer comprising a compatibilizer, thermoplastic elastomer, impact modifier or coupling agent; and a filler.

### BACKGROUND OF THE INVENTION

### Field of the Invention

A polyester-polyolefin based core composition is included that can serve as an alternative layer to PVC for many applications. One suitable application is a surface covering for flooring or walls that may have an included decorative surface.

### Summary of Related Art

Polyvinylchloride (PVC) flooring materials have, in the past, raised concerns regarding emission of toxic gas during incineration and the inclusion of potentially harmful plasticizers. Alternative polymers have been used in an attempt to avoid these concerns, such as polyesters and polyolefins.

Japanese Patent No. 4285984 determined that when a filler is included with an alternative polymer, the resulting product can be very brittle. This was overcome by the inclusion of a specific polymer blend requiring a polyester elastomer, which is a block-copolymer polyester containing soft segments of amorphous or low-crystallinity polyester.

### SUMMARY OF THE INVENTION

The present invention provides an alternative that avoids the need for a polyester elastomer, thereby increasing the potential quantity of recycled polyester and/or polyolefin that may be included in the core composition. Included is a core for a layer in, a decorative floor or wall covering structure including a polyester or copolyester derived from a reaction of a difunctional carboxylic acid and a difunctional hydroxyl compound; a polyolefin, a functionalized polymer including a compatibilizer, a thermoplastic elastomer, impact modifier, or coupling agent; and a filler. This composition provides a core with sufficient range of rigidity and excellent dimensional stability to serve as a layer in floor covering structures. This composition provides a suitable core while excluding a polyester elastomer.

### DETAILED DESCRIPTION OF THE INVENTION

### Definitions

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically the difunctional carboxylic acid can be a dicarboxylic acid and the difunctional hydroxyl compound can be a dihydric alcohol such as, for example, glycols and diols.

The term “glycol” as used in this application includes, but is not limited to, diols, glycols, and/or multifunctional hydroxyl compounds, for example, branching agents. Alternatively, a difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone.

The term “residue”, as used herein, means any organic structure incorporated into a polymer through a polycondensation and/or an esterification reaction from the corresponding monomer.

The term “repeating unit”, as used herein, means an organic structure having a dicarboxylic acid residue and a diol residue. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester.

Furthermore, as used in this application, the term “diacid” includes multifunctional acids, for example, branching agents. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

Core Composition

Polyester

The polyesters included in the core typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 1,4-cyclohexanedimethanol, based on the total diol residues, means the polyester contains 30 mole 1,4-cyclohexanedimethanol residues out of a total of 100 mole % diol residues. Thus, there are 30 moles of 1,4-cyclohexanedimethanol residues among every 100 moles of diol residues.

A variety of different diols are useful as the glycol component of the polyester portion of the polyester compositions. Examples of suitable glycols include glycols that may contain 2 to 16 carbon atoms. Examples of suitable glycols include, but are not limited to, diethylene glycol, ethylene glycol, 2,2,4,4-tetramethyl-1,3-cyclobutanediol, 1,2-propanediol, 1,3-propanediol, neopentyl glycol, 1,4-butanediol, 1,5-pentanediol, 1,6-hexanediol, p-xylene glycol, isosorbide, or mixtures thereof. In another embodiment, the glycols include but are not limited to 1,3-propanediol and/or 1,4-butanediol. In another embodiment, at least one glycol is isosorbide. In one, embodiment, suitable glycols include, but are not limited to, diethylene glycol, ethylene glycol, and 2,2,4,4-tetramethyl-1,3-cyclobutanediol. In one embodiment, suitable glycols includ, but are not limited to, ethylene glycol, and 2,2,4,4-tetramethyl-1,3-cyclobutanediol. In one embodiment, ethylene glycol is the glycol. In one embodiment, 2,2,4,4-tetramethyl-1,3-cyclobutanediol is the glycol.

The polyesters useful in the invention can also comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, or 0.1 to 0.5 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester, in the form of a concentrate as described, for example, in U.S. Pat. Nos. 5,654,347 and 5,696,176, whose disclosure regarding branching monomers is incorporated herein by reference.

The polyesters can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but can be selected from 0.1 percent by weight to about 10 percent by weight, or from 0.1 to about 5 percent by weight, based on the total weight of the polyester.

The polyesters can contain phosphorous compounds including but not limited to phosphoric acid, phosphorous acid, phosphonic acid, phosphinic acid, phosphonous acid, and various esters and salts thereof. These can be present in the polyester compositions useful in the invention. The esters can be alkyl, branched alkyl, substituted alkyl, difunctional alkyl, alkyl ethers, aryl, and substituted aryl. In one embodiment, the number of ester groups present in the particular phosphorous compound can vary from zero, up to the maximum allowable based on the number of hydroxyl groups present on the phosphorus compound used. Examples of phosphorus compounds useful in the invention can include phosphites, phosphates, phosphinates, or phosphonites, including the esters thereof.

The polyester component may include polyethylene terephthalate, polytrimethylene terephthalate, polybutylene terephthalate, glycol-modified polyethylene terephthalate, or combinations thereof. Alternative, or in addition, the polyester component may include a random polymer or copolymer of polyethylene terephthalate, polytrimethylene terephthalate, polybutylene terephthalate, glycol-modified polyethylene terephthalate, or combinations thereof.

The polyester may be present in the core composition in an amount suitable to provide a flooring core composition. Suitable inclusive amounts of polyester are up to about 25%. This includes about 0.1% to about 25% by weight of, the core, such as about 1% to about 21% by weight of the core. Other suitable ranges include about 10% to about 25% or about 15 to about 21% or about 17 to about 21% by weight of the core. The polyester component may be obtained entirely from recycled polyester sources, e.g., 100% post-consumer content. The polyester may be prime or recycled polyester, or a combination of both. One suitable source is plastic water bottles.

Polyolefin

A polyolefin is also included in the core composition. The polyolefin may also be obtained from 100% post-consumer content, 100% post-industrial, prime content, or a combination. Suitable polyolefins include polymers and copolymers of polyethylene, polypropylene, polybutylene, among others or combinations thereof. The polyolefin may include polyolefins selected from the group consisting of high-density polyethylene, low-density polyethylene, linear-low density polyethylene (LLDP), ethylene-vinyl acetate, and ethylene propylene diene terpolymer. The polyofefin component is present in the core composition, in an amount up to about 40%. This includes about 5% to about 40% by weight of the core composition, such as around 5% to about 25%.

Other examples of polyolefins include, but are not limited to, butadiene, pentadiene, hexadiene (e.g., 1,4-hexadiene), heptadiene (e.g., 1,6-heptadiene), octadiene (e.g., 1,7-octadiene), nonadiene (e.g., 1,8-nonadiene), decadiene (e.g., 1,9-decadiene), undecadiene (e.g., 1,10-undecadiene), dodecadiene (e.g., 1,11-dodecadiene), tridecadiene (e.g., 1,12-tridecadiene), tetradecadiene (e.g., 1,13-tetradecadiene), pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and polybutadienes having a molecular weight (Mw) of less than 1000 g/mol. Examples of straight chain acyclic dienes include, but are not limited to 1,4-hexadiene and 1,6-octadiene. Examples of branched chain acyclic dienes include, but are not limited to, 5-methyl-1,4-hexadiene, 3,7-dimethyl-1,6-octadiene, and 3,7-dimethyl-1,7-octadiene. Examples of single ring alicyclic dienes include, but are not limited to, 1,4-cyclohexadiene, 1,5-cyclooctadiene, and 1,7-cyclododecadiene. Examples of multi-ring alicyclic fused and bridged ring dienes include, but are not limited to, tetrahydroindene; norbornadiene; methyltetrahydroindene; dicyclopentadiene; bicyclo(2,2,1)hepta-2,5-diene; and alkenyl-, alkylidene-, cycloalkenyl-, and cylcoalkyliene norbornenes [including, e.g., 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, and 5-vinyl-2-norbornene]. Examples of cycloalkenyl-substituted alkenes include, but are not limited to, vinyl cyclohexene, allyl cyclohexene, vinylcyclooctene, 4-inylcyclohexene, allyl cyclodecene, vinylcyclododecene, and tetracyclododecadiene.

Functionalized Polymer

A functionalized polymer selected from the group consisting of a compatibilizer, impact modifier, thermoplastic elastomer, which may act as a flexibilizer, coupling agent, and combinations thereof, is also included in the core composition. One suitable example is a grafted polyolefin compatibilizer. The grafted polyolefin compatibilizer may include one or more polyolefins selected from the group consisting of polypropylene, high-density polyethylene, low-density polyethylene, linear, low-density polyethylene, ethylene-vinyl acetate, and ethylene propylene diene terpolymer, which has been grafted with a monomer selected from the group consisting of maleic anhydride, glycidyl methacrylate, and acrylic acid. The functionalized polymer may be present in an amount of about 0% to about 5.0% by weight of the core composition, such as about 0% to about 2.5%. Other suitable examples include 0.01% to about 5.0% or about 1.0% to about 2.5%.

One suitable example is a thermoplastic elastomer copolymer. The thermoplastic elastomer copolymer may include one or more selected from the group consisting of ethylene vinyl acetate, ethylene methylacrylate, ethylene butylacrylate, polybutyrate, butene, octene, or hexene polyolefin, propylene. The thermoplastic elastomer copolymer may be present in an amount of up to about 25%. This includes 0.1% to about 25% by weight of the core composition, such as around 1% to about 15%.

The thermoplastic polyolefin may be a metallocene catalyzed polyolefin such as a polyethylene or polypropylene based polymer. The polyolefin polymer can be prepared by polymerizing ethylene or propylene with one or more dienes. In at least one other specific embodiment, the polyolefin polymer can be prepared by polymerizing propylene with ethylene and/or at least one C4-C20 α-olefin, or a combination of ethylene and at least one C4-C20 α-olefin and one or more dienes. The one or more dienes can be conjugated or non-conjugated. Preferably, the one or more dienes are non-conjugated.

The comonomers can be linear or branched. Linear comonomers include ethylene or C4-C8 α-olefin, such as ethylene, 1-butene, 1-hexene, and 1-octene. Branched comonomers include 4-methyl-1-pentene, 3-methyl-1-pentene, and 3,5,5-trimethyl-1-hexene. In one or more embodiments, the comonomer can include styrene.

Illustrative dienes can include, but are not limited to, 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopendadiene (DCPD), and combinations thereof.

Suitable methods and catalysts for producing the polyolefin polymers are found in publications US 2004/0236042 and WO05/049672 and in U.S. Pat. No. 6,881,800, which are all incorporated by reference herein. Pyridine amine complexes, such as those described in WO03/040201 are also useful to produce the propylene-based polymers useful herein. The catalyst can involve a fluxional complex, which undergoes periodic intra-molecular re-arrangement so as to provide the desired interruption of stereo regularity as in U.S. Pat. No. 6,559,262, which is incorporated herein by reference. The catalyst can be a stereorigid complex with mixed influence on propylene insertion, see Rieger EP1070087, which is incorporated herein by reference. The catalyst described in EP1614699, which is incorporated herein by reference, could also be used for the production of backbones suitable for the some embodiments of the present disclosure.

Other suitable examples of thermoplastic elastomers include, but is not limited to, styrene/butadiene rubber (SBR), styrene/isoprene rubber (SIR), styrene/isoprene/butadiene rubber (SIBR), styrene-butadiene-styrene block copolymer (SBS), hydrogenated styrenebutadiene-styrene block copolymer (SEBS), hydrogenated styrene-butadiene block copolymer (SEB), styrene-isoprenestyrene block copolymer (SIS), styrene-isoprene block copolymer (SI), hydrogenated styrene-isoprene block copolymer (SEP), hydrogenated styrene-isoprene-styrene block copolymer (SEPS), styrene-ethylene/butylene-ethylene block copolymer (SEBE), styrene-ethylene-styrene block copolymer (SES), ethylene-ethylene/butylene block copolymer (EEB), ethylene-ethylene/butylene/styrene block copolymer (hydrogenated BR-SBR block copolymer), styrene-ethylene/butylene-ethylene block copolymer (SEBE), ethylene-ethylene/butylene-ethylene block copolymer (EEBE), polyisoprene rubber, polybutadiene rubber, isoprene butadiene rubber (IBR), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; poly(isobutylene-co-alkylstyrene), suitable isobutylene/methylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof. The additional elastomeric components include hydrogenated styrene-butadienestyrene block copolymer (SEBS), and hydrogenated styreneisoprene-styrene block copolymer (SEPS).

Fillers and Additives

A variety of fillers and additives may be included in the core composition. Suitable examples include, but are not limited to, limestone (CaCO3), natural or synthetic fiber, glass beads, glass fiber, glass bubbles, clay, talc, dolomite, silica, and combinations thereof. Reinforcing additives may include carbon filaments, silicates, mica, clay, talc, titanium dioxide, Wollastonite, glass flakes, glass beads and fibers, polymeric fibers, and combinations thereof. The additives and fillers may be present in any suitable amount, such as about 30% to about 95% by weight of the core composition.

The core composition can be useful in forming fibers, films, molded articles, foamed articles, containers, and sheeting. The methods of forming the polyesters into fibers, films, molded articles, containers, and sheeting are well known in the art.

Also included are articles of manufacture. These articles include, but are not limited to, injection molded articles, injection blow molded articles, injection stretch blow molded articles, extrusion blow molded articles, extrusion stretch blow molded articles, extrusion sheeted articles, extrusion casted articles, double-belt pressed articles, calendered articles, and compression molded articles. Methods of making the articles of manufacture, include, but are not limited to, extrusion blow molding, extrusion stretch blow molding, injection blow molding, injection stretch blow molding, extrusion sheeting, extrusion casting, double-belt pressing, calendering, rotomolding, compression molding, and solution casting. The article may include a sheet, plank or tile to which a decorative surface is added. Such articles are useful for many applications such as flooring or walls.

The core composition may have properties and viscosity values that make them suitable, after adjusting their molecular weight, for use in numerous practical applications such as films, injection molded products, extrusion coatings, fibres, foams, thermoformed products, extruded profiles and sheets, extrusion blow molding, injection blow molding, rotomolding, stretch blow molding, etc.

The methods of forming the core composition into film(s) and/or sheet(s) are well known in the art. Examples of film production technologies include film blowing, casting and extrusion. Examples of film(s) and/or sheet(s) of the invention including but not limited to, extruded film(s) and/or sheet(s), extrusion casted film(s) and/or sheet(s), double-belt pressed film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

Examples of potential articles made from film and/or sheet include, but are not limited, to uniaxially stretched film, biaxially stretched film, shrink film (whether or not uniaxially or biaxially stretched), liquid crystal display film (including, but not limited to, diffuser sheets, compensation films and protective films), thermoformed sheet, graphic arts film, outdoor signs, skylights, coating(s), coated articles, painted articles, laminates, laminated articles, and/or multiwall films or sheets.

When the core composition is to be used as a layer in a decorative covering, structure, the composition is first extruded or calendered into core sheet and then cut or punched into a sheet, tile, plank, or any suitable configuration. A decorative surface may then be added such as by direct printing, addition of a vinyl tile, paper, printed film, back printed wear film, wood veneer, etc. When a wood veneer is added, it may be bonded in the absence of an adhesive. When a decorative layer, including a film, is added it may be adhered using no adhesive, hot melt adhesive, hot melt PUR adhesive cast extruded tie-layer, co-extruded tie-layer, or any other adhesive technology. Prior to addition of the decorative layer, the surface of the core or decorative layer may be modified to enhance the bond of the decorative layer. This modification or treatment may include sanding, texturing, and corona treatment, among others and combinations thereof.

The features and advantages of the present invention are more fully shown by the following examples which are provided for purposes of illustration, and are not to be construed as limiting the invention in any way.

### EXAMPLES

Calendering Method

A batch consisting of 14 pounds post-industrial recycled linear-low density polyethylene, 5 pounds Ethylene Methyl Acrylate, and 1 pounds Polyethylene Terephthalate were dry-blended using a rotary mixer. The blended batch was compounded using a twin-screw extruder with a melt temperature of 245° C., stranded in a water bath and cut into pellets with pelletizing equipment. The compounded pellets were then fed in a 1:4 ratio with calcium carbonate into the feed throat of a compounding continuous mixer. The material compounded dropped out of the mixer into a two-roll calendar at approximately 202° C. The material was sheeted out into a core of approximately 0.125 inch thickness. This sheeted core material had a flexural modulus of 77,373 PSI and dimensional change of −0.02% when exposed to 98.9° C. for 6 hours and returned to room temperature.

Extruded Sheeting Method

A batch consisting of 6 pounds post-industrial recycled linear-low density polyethylene, 3 pounds Polybond 3349 Compatibilizer, and 21 pounds Polyethylene Terephthalate were dry-blended using a rotary mixer. The blended batch was compounded using a twin-screw extruder with a melt temperature of 245° C., with 70% by weight calcium carbonate added during compounding to make a homogeneous blend. This material then was processed through a gear pump and sheet die and cooled through a cooling line to form a core of approximately 0.160 inch thickness. This sheeted core material had a flexural modulus of 1,054,794 PSI and dimensional change of 0.02% when exposed to 70° C. for 6 hours and returned to room temperature.

Table 1 and 2 include various compositions of some embodiments.

TABLE 1

| | Recycled | Recycled | | CaCO3 | Compati- |
|---|---|---|---|---|---|
| | LLDP wt | PET wt | Flexibilizer | Filler | bilizer |
| Composition | fraction | Fraction | Wt % | Wt % | % |
| A | 15.49 | 0.00 | 6.45 | 78.05 | 0.00 |
| B | 14.14 | 3.00 | 4.94 | 77.92 | 0.00 |
| C | 14.14 | 3.00 | 4.94 | 77.92 | 0.00 |
| D | 14.14 | 3.00 | 4.94 | 77.92 | 0.00 |
| E | 14.14 | 3.00 | 4.94 | 77.92 | 0.00 |
| F | 13.97 | 3.00 | 4.94 | 78.09 | 0.00 |
| G | 14.00 | 1.00 | 5.00 | 80.00 | 0.00 |
| H | 18.00 | 1.00 | 1.00 | 80.00 | 0.00 |
| I | 16.00 | 3.00 | 1.00 | 80.00 | 0.00 |
| J | 12.00 | 3.00 | 5.00 | 80.00 | 0.00 |
| K | 14.00 | 1.00 | 5.00 | 80.00 | 0.00 |
| L | 18.00 | 1.00 | 1.00 | 80.00 | 0.00 |
| M | 6.00 | 21.00 | 0.00 | 70.00 | 3.00* |

*Polybond 3349—Linear Low Density Polyethylene Grafted with Maleic Annhydride (1-1.4%)

TABLE 2

| | Thermoplastic | |
|---|---|---|
| | Elastomer | Thermoplastic |
| | (Flexibilizer) | Elastomer |
| Composition | Trade Name | Chemical Name |
| A | Engage 8401 | Polyolefin Elastomer |
| B | Exact 4049 | Plastomer |
| | | (ethylene based butene) |
| C | Engage 8200 | Polyolefin Elastomer |
| D | Vistamaxx 6102 | Polypropylene Elastomer |
| E | Vistamaxx 6202 | Propylene Elastomer |
| F | Engage 8402 | Polyolefin Elastomer |
| G | Lotryl 29MA03T | Ethylene methyl acrylate |
| | | (27-31% methyl acrylate content) |
| H | Lotryl 29MA03T | Ethylene methyl acrylate |
| | | (27-31% methyl acrylate content) |
| I | Evatane 40-55 | Ethylene vinyl acetate |
| | | (38-41% vinyl acetate content) |
| J | Evatane 40-55 | Ethylene vinyl acetate |
| | | (38-41% vinyl acetate content) |
| K | Escorene LD713.93 | Ethylene vinyl acetate |
| | | (14.4% vinyl acetate) |
| L | Escorene LD713.94 | Ethylene vinyl acetate |
| | | (14.4% vinyl acetate) |

Table 3 provides testing data demonstrating the favorable properties of the composition as a floor or wall covering.

TABLE 3

| | | Machine Direction | |
|---|---|---|---|
| | Flexural | Dimensional Stability# | Dimensional |
| | Modulus* | heated for 6 hours | Stability Test# |
| Composition | (psi) | % length Change | Temperature ° C. |
| G | 77373 | −0.02% | 98.9 |
| H | 94057 | 0.00% | 98.9 |
| I | 104299 | 0.00% | 98.9 |
| J | 76038 | −0.01% | 98.9 |
| K | 86327 | −0.06% | 98.9 |
| L | 96682 | −0.01% | 98.9 |
| M | 1054794 | 0.02% | 70 |

*ASTM D790
#ASTM F2199

While there have been described what are presently believed to be the preferred embodiments of the invention, those skilled in the art will realize that changes, and modifications may be made thereto without departing from the spirit of the invention, and it is intended to include all such changes and modifications as fall within the true scope of the invention.

1. A core for a decorative floor or wall covering including:
(a) a polyester comprising a polyester or copolyester derived from a reaction of a difunctional carboxylic acid and a difunctional hydroxyl compound;
(b) a polyolefin,
(c) at least one functionalized polymer comprising a compatibilizer, thermoplastic elastomer, impact modifier or coupling agent; and
(d) a filler.

2. The core of claim 1, wherein said polyester comprises polyethylene terephthalate, polytrimethylene terephthalate, polybutylene terephthalate, glycol-modified polyethylene terephthalate, or combinations thereof.

3. The core of claim 1, wherein said polyester comprises random copolymer of polyethylene terephthalate, polytrimethylene terephthalate, polybutylene terephthalate, glycol-modified polyethylene terephthalate, or combinations thereof.

4. The core of claim 1, wherein said polyester is present in an amount of about 10% to about 25% by weight of the core.

5. The core of claim 1, wherein said polyolefin is present in an amount of about 5% to about 25% by weight of the core.

6. The core of claim 1, wherein said functionalized polymer comprises a grafted polyolefin compatiblizer.

7. The core of claim 6, wherein said grafted polyolefin compatibilizer is present in an amount of about 1% to about 2.5% by weight of the core.

8. The core of claim 6, wherein said filler is present in an amount of about 30% to about 80% by weight of the core.

8a. The core of claim 1, wherein said functionalized polymer comprises a thermoplastic elastomer.

9. The core of claim 1, wherein said polyester is a recycled polymer comprising polyethylene terephthalate, polytrimethylene terephthalate, polybutylene terephthalate, or glycol-modified polyethylene terephthalate or combinations thereof.

10. The core of claim 1, wherein said polyolefin is selected from the group consisting of polyethylene, polypropylene, polybutylene, high-density polyethylene, low-density polyethylene, linear, low-density polyethylene, and combinations thereof.

11. The core of claim 1, wherein said grafted polyolefin compatibilizer includes one or more polyolefins selected from the group consisting of high-density polyethylene, low-density polyethylene, linear, low-density polyethylene, ethylene-vinyl acetate, and ethylene propylene diene terpolymer, which has been grafted with a monomer selected from the group consisting of maleic anhydride, glycidyl methacrylate, and acrylic acid.

12. The core of claim 1, wherein said filler is selected from the group consisting of limestone (CaCO₃), natural or synthetic fiber, glass beads, glass fiber, glass bubbles, clay, talc, dolomite, silica, and combinations thereof.

13. The core of claim 1, wherein a surface of said core has been modified.

14. The core of claim 1, wherein a surface of said core has been modified by one or more treatments selected from sanding, texturing, and corona treatment.

15. The core of claim 13, further comprising a decorative layer adjacent to the modified surface of said core.

16. The core of claim 15, further comprising an adhesive between said modified surface of said core and said decorative layer.

17. A decorative tile or plank for flooring or walls comprising the core of claim 1 and a decorative layer.
